(19) United States
(12) Patent Application Publication
(10) Pub. No.: US 2008/0255864 A1
(43) Pub. Date: Oct. 16, 2008

(54) METHOD AND COMPUTER PROGRAM PRODUCT FOR CREATING ON DEMAND COMMERCIAL SHIPPING INVOICES

(75) Inventors: Scott Aubuchon, Alpharetta, GA (US); Randy Coleman, Roswell, GA (US); John Slayton, Suwanee, GA (US); Kurt L. Stadele, Alpharetta, GA (US); Stephen R. York, Acworth, GA (US); Matt Young, Alpharetta, GA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: United Parcel Service of America, Inc.

(21) Appl. No.: 11/734,548

(22) Filed: Apr. 12, 2007

(51) Int. Cl. G06Q 50/00; B41M 99/00; G06K 9/00

(52) U.S. Cl. 705/1; 101/483; 382/101

(57) ABSTRACT

A method and computer program product for creating an international commercial shipping invoice on demand. In various embodiments, the method comprises storing an electronic copy of a shipping entity's identification indicator, storing an electronic copy of the shipping entity's shipping signature, receiving invoice data relating to the parcel shipment, and subsequently combining the identification indicator and the shipping signature with the invoice data to generate an on demand signed international commercial shipping invoice. In various embodiments, a signed international commercial shipping invoice may be generated by a parcel shipment carrier subsequent to receiving invoice data. In other embodiments, an international commercial shipping invoice may be generated by a customs broker upon request by an importing agent during customs processing. In any respect, the present invention reduces the time and costs associated with creating signed paper copies of international commercial invoices by separately capturing the individual components of an international commercial shipping invoice, and allowing these components to be subsequently assembled, upon demand, to generate the completed invoice.

### FIELD OF THE INVENTION

In general, embodiments of the present invention relate to international shipping functions, and, in particular, to creating international shipping invoices.

### BACKGROUND OF THE INVENTION

The international supply chain of goods has been spurred on by, among other things, trade globalization and modern manufacturing processes. These have allowed many businesses to become involved in the international supply chain of goods. A given manufacturer frequently obtains assembly components from suppliers located in various countries and each of the suppliers, in turn, may obtain subcomponents from suppliers in other countries, and so on. It is the norm that products may have subcomponents made in various countries. Coupled with the prevalence of ‘just-in-time’ inventory management, timely international shipping of parts is a critical aspect of maintaining orderly and efficient supply chain management. Facilitating importation of such shipments is critical to modern manufacturing processes and providing an efficient global trade economy.

However, importing goods of a shipment is a complicated process involving many regulations that vary from country to country. Most countries have adopted an international goods classification scheme for categorizing goods. The scheme provides a classification number along with a description of the goods. The importing country assigns a duty rate based on the classification of the goods. Thus, the duty rate in conjunction with the value of the goods (and other factors) allows calculation of the duties and taxes to be paid to customs for the imported goods. Additionally, many countries restrict the type of goods that can be imported under the auspices of international trade agreements or unilateral regulation by the importing country. Special permits may be required for importing particular goods to a particular consignee. Finally, each country has different documentation requirements that must be met. In particular, many countries have specific requirements relating to the commercial invoice associated with a particular shipment. These requirements typically include providing the shipping entity's letterhead and/or logo, a description of the goods, a unit value of the goods, a total value of the goods, and a shipping signature.

Once a shipment has been rated (and assuming none of the items are restricted from importation), required duties and tariffs must be paid to the appropriate governmental agency, typically the Customs Office. The carrier typically communicates information regarding the shipment, often in the form of an international commercial shipping invoice, to a customs broker. Importing agents typically review documentation associated with the shipment and verify the amount due. Once the amount due is collected by the Customs Office and the importing agents have reviewed the appropriate documentation, the Customs Office issues a “customs clearance” to the carrier indicating that delivery to the consignee may proceed. Usually, if goods have arrived at that importing port or terminal, the imported goods are temporarily stored until clearance is obtained, and then local delivery of the goods continues. To minimize storage costs and delays, it is desirable to provide accurate and complete information to the Customs Office to facilitate a timely clearance response for a shipment.

For the carrier(s) shipping the goods, the myriad regulations, which also vary from country to country, present a complicated logistics operation that benefits from the application of computer systems. Specialized customs brokerage agents exist in various countries to facilitate importation of goods and these agents may use computerized systems to assist them. As the need and scope of international shipping increases, the desire to further reduce costs, minimize delays, and speed up delivery times becomes more significant. Many countries have modified their commercial invoice requirements to take advantage of the speed and convenience that computer systems and corresponding paperless records allow. However, many other countries still require a printed, signed, paper copy of a commercial invoice. Although a handful of countries that require a signed, paper copy of a commercial invoice have additional requirements that necessitate an original shipping entity signature (such as those countries that require that the shipping signature appear in blue ink), a majority of the other countries allow digitally reproduced shipping signatures.

Many shipping entities continue to create original signed paper invoices that are physically attached to a parcel shipment. Other shipping entities create original signed invoices that are then converted into an electronic invoice record. This record is then sent to a carrier and electronically accompanies the parcel during shipment. In either instance, however, given the increasing volumes of international parcel shipments, these processes are time consuming for both the shipping entity, who must prepare the original signed invoices, and the carriers who must locate and track the invoices through shipment.

Thus, there is a need for an improved method of creating an international commercial shipping invoice to be associated with a parcel shipment. The method should aid in reducing the time and costs associated with creating signed paper copies of commercial invoices, and should be configured to generate a signed commercial invoice on demand. The method should also be configured to include information typically required for international commercial invoices, and should record and store such information.

### BRIEF SUMMARY OF THE INVENTION

Exemplary embodiments of the present invention provide an improvement over the known prior art by, among other things, providing a method and computer program product for creating an international commercial shipping invoice on demand. The present invention reduces the time and costs associated with creating signed paper copies of international commercial invoices by separately capturing the individual components of an international commercial shipping invoice, and then allowing these components to be subsequently assembled, upon demand, to generate the completed invoice. As a result, a shipping entity need not prepare an original signed paper copy of an international commercial invoice for parcel shipments destined for countries for which an original signed paper copy of an international commercial invoice is not required. Rather, a signed international commercial shipping invoice may be subsequently created, such as, for example, by the carrier prior to shipping the parcel shipment or by a customs broker in response to a request by an importing agent for further documentation.

In one embodiment, the present invention provides a method of creating an on demand international commercial shipping invoice associated with shipment of a parcel that comprises storing an electronic copy of a shipping entity's identification indicator, storing an electronic copy of the shipping entity's shipping signature, receiving invoice data relating to the parcel shipment, and subsequently combining the identification indicator and the shipping signature with the invoice data to create an on demand signed international commercial shipping invoice. In another embodiment, the method further comprises providing an electronic commercial shipping invoice template and wherein the step of subsequently combining the identification indicator and the shipping signature with the invoice data comprises populating the electronic commercial shipping invoice template with the identification indicator, shipping signature, and invoice data. Another embodiment further comprises associating the identification indicator and the shipping signature with the shipping entity. Another embodiment further comprises determining a tracking number for the parcel shipment, associating the tracking number with the invoice data and the shipping entity, and storing the invoice data and the tracking number. In another embodiment, the step of subsequently combining the identification indicator and the shipping signature with the invoice data occurs upon request by an importing agent. Another embodiment further comprises associating a printed shipping label with the parcel, the shipping label including machine readable data corresponding to the invoice data. In a related embodiment, the machine readable data is readable by at least one of a barcode reader, a MaxiCode reader, a PDF417 reader, or an RFID reader. In another embodiment, the step of receiving invoice data comprises receiving package level detail data. In another embodiment, the step of receiving an electronic copy of the shipping entity's identification indicator comprises storing at least one of the shipping entity's letterhead or the shipping entity's logo. Another embodiment further comprises printing a paper version of the on demand signed international commercial shipping invoice upon request by an importing agent.

In addition to the exemplary embodiments relating to methods of creating an on demand signed international commercial shipping invoice, the present invention also provides exemplary embodiments relating to computer program products for creating an on demand signed international commercial shipping invoice as similarly described above.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic representation of a network environment configured for providing an on demand international commercial shipping invoice in accordance with one exemplary embodiment of the present invention;

FIG. 2 is a schematic representation of a method of creating an on demand international commercial shipping invoice in accordance with one exemplary embodiment of the present invention;

FIG. 3 is a schematic representation of a method of creating an on demand international commercial shipping invoice in accordance with another exemplary embodiment of the present invention;

FIG. 4 shows an example of a machine readable parcel label in accordance with an exemplary embodiment of the present invention;

FIG. 5 shows an example of a shipping entity's identification indicator and shipping signature in accordance with an exemplary embodiment of the present invention;

FIG. 6 shows an example of a commercial shipping invoice template in accordance with an exemplary embodiment of the present invention;

FIG. 7 shows an example of invoice data in accordance with an exemplary embodiment of the present invention;

FIG. 8 shows an example of an completed on demand signed international commercial shipping invoice in accordance with an exemplary embodiment of the present invention; and

FIG. 9 is a block diagram of an exemplary electronic device configured to execute an on demand international commercial shipping invoice of exemplary embodiments of the present invention.

### DETAILED DESCRIPTION OF THE INVENTION

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

Carriers (i.e., parcel delivery companies) have developed shipping software for shipping entities (e.g., customers of the carriers) allowing the shipping entities to enter their shipping records into personal computers, from where the records are uploaded to the carrier's computer system. Accordingly, the shipping records no longer need to be manually keyed into the delivery company's computer system. Further, the shipping software prints machine readable parcel labels that allow the parcels to be machine sorted, which is both more efficient and more accurate. Thus, the shipping software, along with the tracking software, permits parcel delivery companies to provide shipping customers with improved, more efficient service.

These shipping systems typically prompt, accept, and verify invoice data provided by the shipping customer, write the invoice data to a file, and then transmit the file to a second computer, such as a server, operated by the carrier. The data transmitted typically also includes a tracking number. In various embodiments, the tracking number may include an indicium identifying the number as a tracking number, a customer account number, a level of service indicator corresponding to the level of service indicated in the level of service indicating region, and a predetermined reference number determined by the shipping service provider. The customer account number may include payment indicia corresponding to a type of payment by a customer of the carrier for shipment of the package, the payment indicia corresponding, for example, to a pre-established account of the customer with the carrier, or a credit card payment.

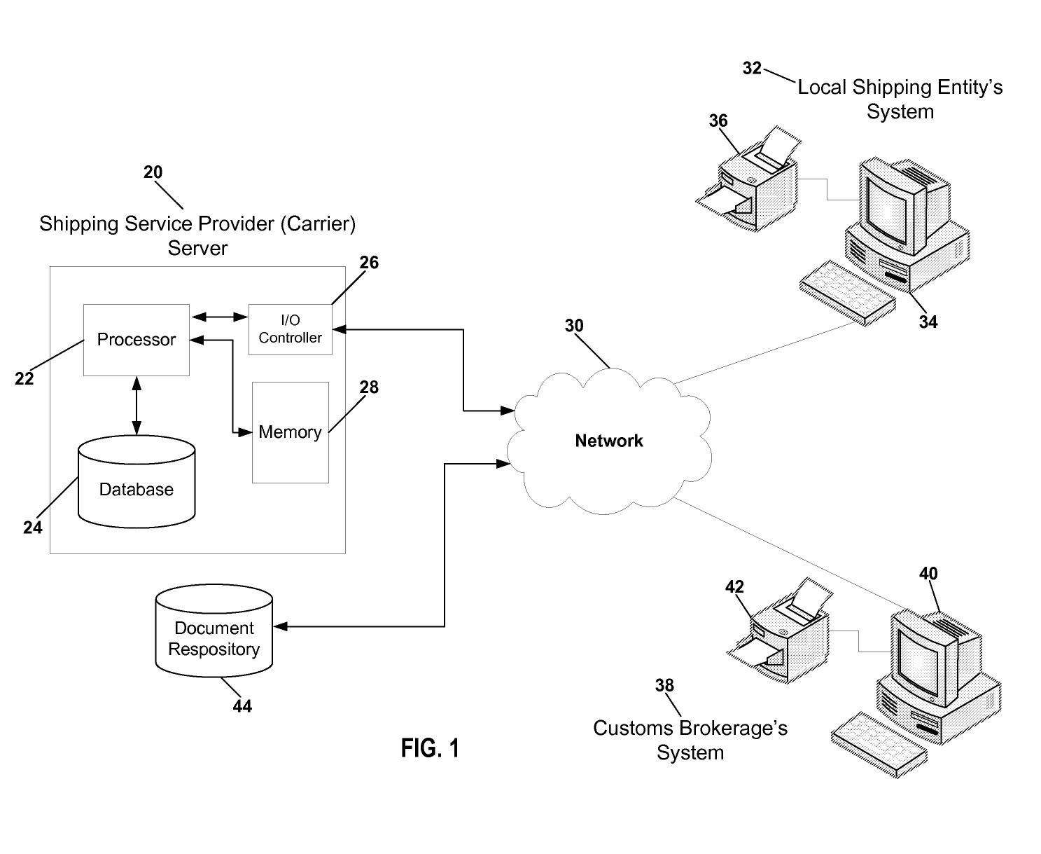

Referring to FIG. 1, the shipping system functions as a local shipping system relative to the user and remote relative to a server operated by the carrier. In this embodiment, a server 20, is typically operated by the carrier and communicates with the shipping entity system 32. Although only one shipping entity system is shown, typically there are many shipping entity systems associated with various users (such as other customers of the carrier) that can communicate with the carrier's server 20. The server 20 typically comprises a processor 22 that communicates with a database 24, which can be viewed as a form of secondary memory, as well as primary memory 26. The processor also communicates with external devices using an I/O controller 28 that typically interfaces with a network 30. In various embodiments, the network 30 may a LAN, a WAN, the Internet, etc. The network may also provide local connectivity between a printer 36 and the shipping entity system 32. Communication between the server 20 and the shipping entity system 32 typically is accomplished by routing data through the network 30. The shipping entity system 32 may interact with the server 20 in a client-server manner in which the shipping entity system 32 executes a web-based browser. Alternatively, the shipping entity system 32 may interact with the server on a peer-to-peer or master-slave basis. An example of a shipping system as described above is the UPS WorldShip™ software solution.

It should be noted that those skilled in the art of data networking will realize that many other alternatives and architectures are possible that can be used to practice the principles of the present invention. The embodiments illustrated in FIG. 1 can be modified to use other technologies and still be within the scope of the present invention as claimed.

As noted above, different countries have different documentation requirements that must be met in the processing of international shipments. In particular, many countries have specific requirements relating to commercial invoices associated with parcel shipments. Often, these requirements include providing the shipping entity's letterhead and/or logo, a description of the goods, a unit value of the goods, a total value of the goods, and a shipping signature. The present invention provides a method and computer program product for creating a signed international commercial shipping invoice on demand. For example, in various embodiments, an invoice may be created by a carrier subsequent to receiving invoice data. In other embodiments, an invoice may be created by a customs broker upon request by an importing agent during customs processing. In any respect, the present invention reduces the time and costs associated with creating signed paper copies of international commercial shipping invoices by separately capturing the individual components of the invoice, and allowing these components to be subsequently assembled to generate the completed invoice. In this manner, a shipping entity need not prepare an original signed paper copy of a signed international commercial shipping invoice for parcel shipments destined for countries for which an original signed paper copy of the invoice is not required. Rather, the signed international commercial shipping invoice may be subsequently created when needed.

As noted above, carriers have developed shipping software for customers allowing customers to enter their shipping records into personal computers, from where the records are uploaded to the carrier's computer system. Thus, when a shipping entity desires to create an international parcel shipment, the shipping entity system 32 typically prompts, accepts, and verifies invoice data provided by the shipping entity. The invoice data is then stored in a record, which record is then transmitted to the carrier's server 20.

In accordance with various embodiments of the present invention, the server may also contain other stored data relating to a particular shipping entity. Such other data may include an electronic copy of a shipping entity's identification indicator and an electronic copy of a shipping entity's shipping signature. The identification indicator may include, but is not limited to, an electronic copy of the shipping entity's letterhead and/or logo. The shipping entity's signature may include, but is not limited to, an electronic copy of the handwritten signature of a person (or persons) who, on behalf of the shipping entity, may sign the shipping entity's commercial invoices. The identification indicator and the shipping signature may be stored and associated with the particular shipping entity on the carrier's server 20, such that each may be accessed, used, and/or reproduced at a later time. Although not a limitation of the present invention, in various embodiments a shipping entity may provide to the carrier the shipping entity's identification indicator and shipping signature in connection with an agreement with the carrier to participate in “paperless” invoicing. Such an agreement may include instructions for the shipping entity to include specific details within the invoice data such that the invoice data may be used to create an international commercial shipping invoice in compliance with general customs requirements. For example, many countries may require a detailed description of the goods, a unit value of the goods, a total value of the goods, etc.

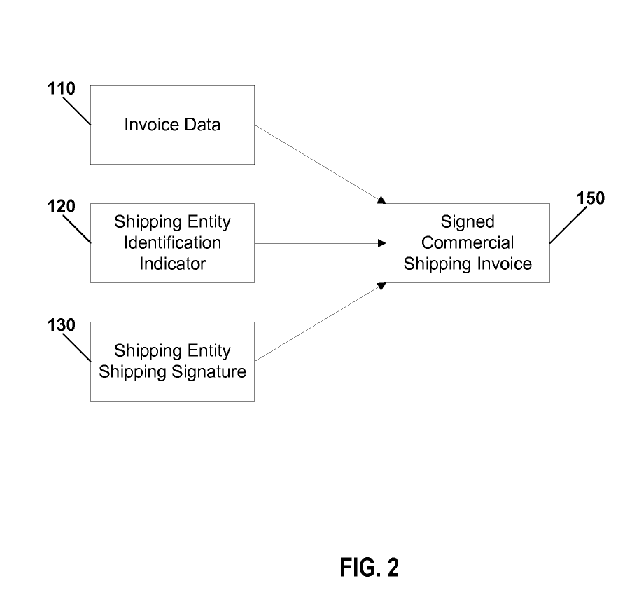

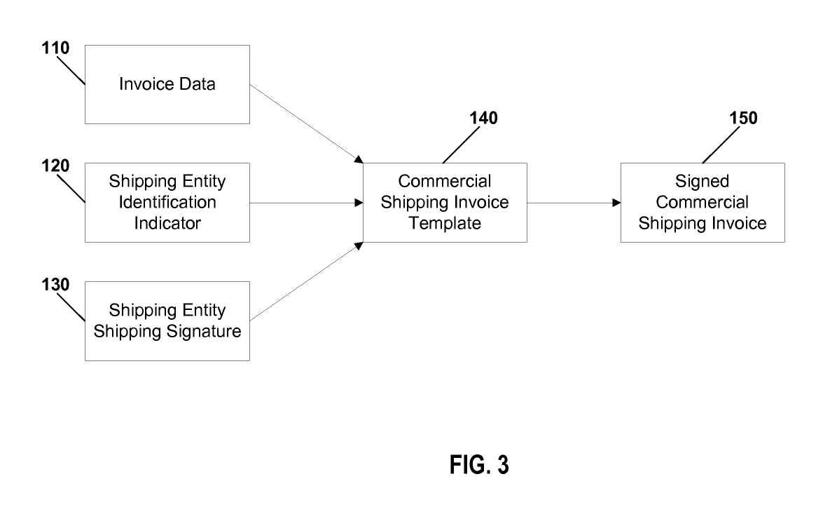

FIGS. 2 and 3 show general block diagrams representing two exemplary alternatives for creating an on demand signed international commercial shipping invoice 150. However, it should be noted that many other alternatives exist to create an on demand signed international commercial shipping invoice in accordance with the present invention. In the depicted embodiment of FIG. 2, the completed invoice 150 is created by subsequently combining invoice data 110 relating to a particular parcel shipment, with an identification indicator 120 and a shipping signature 130 that are associated with a shipping entity. In the depicted embodiment of FIG. 3, the completed invoice 150 is created by populating an electronic commercial invoice template 140 with invoice data 110 relating to a particular parcel shipment, an identification indicator 120, and a shipping signature 130 associated with a shipping entity. In various embodiments, different forms of a commercial shipping invoice template 140 are possible. For example, a generic commercial invoice template 140 may be stored on the carrier's server 20, a commercial invoice template may be associated with a particular shipping entity, or a commercial invoice template may be generated with each shipment. In any event, the resulting signed international commercial shipping invoice includes substantially the same or similar data.

As noted above, the present invention is intended to create a signed international commercial shipping invoice upon demand. As noted above, many countries have modified their commercial invoice requirements to take advantage of the speed and convenience that computer systems and corresponding paperless records allow. In accordance with an embodiment of the present invention, a signed international commercial shipping invoice may be created on demand by a carrier prior to shipping the parcel shipment. Referring to FIG. 1, in such an embodiment, the signed international commercial invoice may be printed in paper form and attached to the parcel shipment. Alternatively, an electronic copy of the invoice may be stored in the database 24 of the carrier's server, or in a document repository 44, accessible by a third party, such as a customs broker operating a computer system 38 that interfaces with the network 30. As such, the customs broker may access and, if needed, print a paper copy of the signed international commercial shipping invoice using a printer 42.

In another embodiment, the customs broker may create a signed international commercial shipping invoice on demand. In such an embodiment, the components of the invoice (i.e., the invoice data, the identification indicator, and the shipping signature) are stored in electronic form in the carrier server database 24, or alternatively, in the document repository 44. As a result, should the customs broker desire to create a signed international commercial shipping invoice associated with a particular parcel shipment, the broker may access the invoice data, the identification indicator, and the shipping signature, and combine them to create a signed international commercial shipping invoice. As noted, this invoice may be printed on the custom broker's printer 42 if a paper copy is desired. It should be noted that in other embodiments of the present invention, any one or any combination of the invoice data, identification indicator, or the shipping signature may reside in a database associated with the shipping entity system 32. In such an embodiment, the custom broker may have the ability to access the data from the shipping entity system 32 through the network 30.

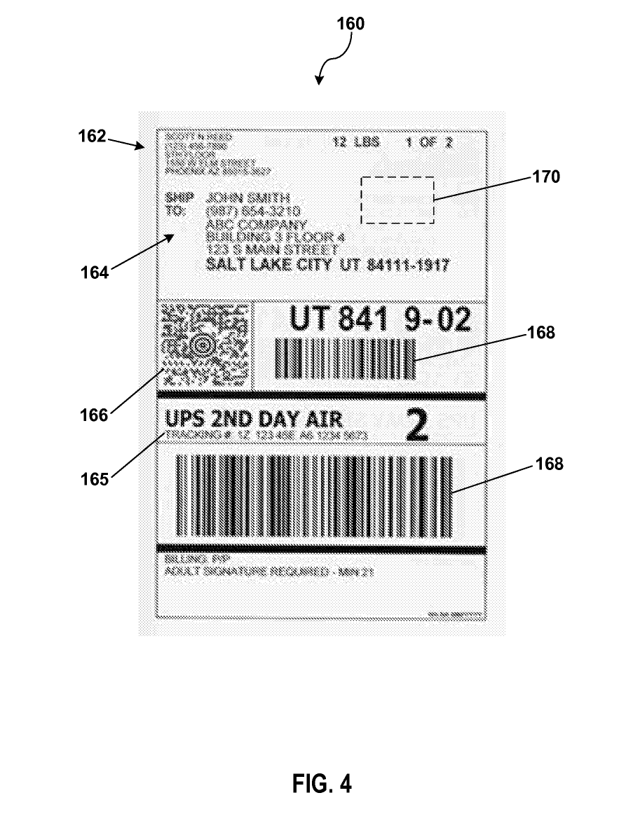

In another embodiment of the present invention, any one or any combination of the invoice data, identification indicator, or shipping signature may be stored electronically on a machine readable parcel label, which is typically attached to a parcel shipment prior to shipping. An example of a machine readable parcel label 160 is shown in FIG. 4. The label 160 may include various text portions including ship-from information 162, ship-to information 164, and a tracking number 165. Additionally, the label 160 may include machine readable symbols, such as MaxiCode 166 and barcode 168 symbols that store various data. In addition to, or in the place of, the barcode and MaxiCode symbols 166, 168, the label 160 may include one or more radio frequency identification (RFID) transponders 170 capable of storing a variety of data. Additionally, although not shown in the figure, the label 160 may also include a PDF417 barcode that may include a variety of data relating to the package shipment. In accordance with the present invention, any one or any combination of the invoice data, identification indicator, or the shipping signature may be stored on the label 160. In one embodiment, the data may be stored within the machine readable symbols, 166, 168 or other machine readable symbols such as a PDF417 barcode. In another embodiment, the data may be stored in the RFID transponder 170. As a result, a signed international commercial shipping invoice may be created by combining the stored components. Such embodiments may be useful as an alternative to, or as a backup to, the embodiments described above.

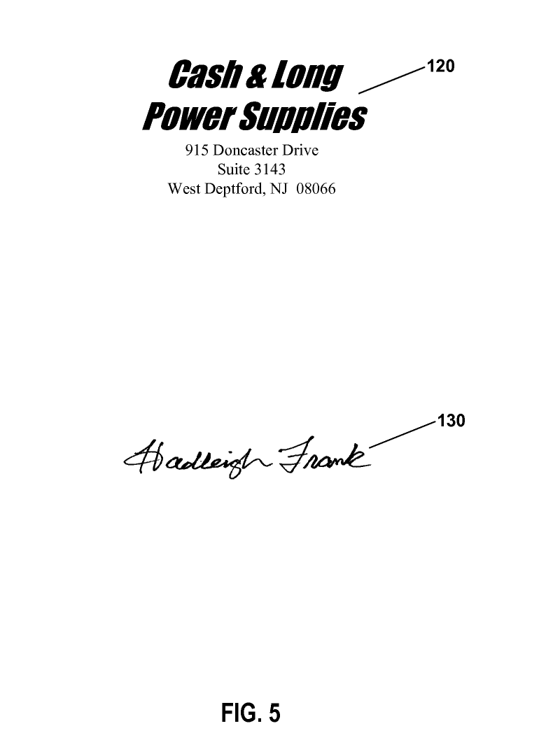

FIGS. 5-8 show components of a fictional parcel shipment that are combined in accordance with one embodiment of the present invention to create an on demand signed international commercial shipping invoice.

FIG. 5 shows a fictional example of a shipping entity's identification indicator 120 and the shipping entity's shipping signature 130. As noted above, in accordance with various embodiments of the present invention, a shipping entity's identification indicator 120 and a shipping entity's shipping signature 130 may be received by a carrier, associated with the particular shipping entity, and stored in electronic format on the carrier's server (or other accessible location). As noted above, in many embodiments the identification indicator 120 and the shipping signature 130 may be received in connection with a contractual agreement with the carrier. However, it should be noted that other embodiments are possible, such as embodiments in which the identification indicator and/or the shipping signature are provided by the shipping entity with the invoice data.

In the depicted embodiment, the shipping entity's identification indicator 120 includes the shipping entity's letterhead, which includes the shipping entity's address. In various embodiments, the shipping identification indicator 120 may be any symbol, or any combination of text, figures, symbols, colors, etc. that may be associated with a shipping entity. Many countries require that a shipping entity's letterhead and/or logo be included on a commercial shipping invoice. Thus, although the present invention should not be limited to an identification indicator of any particular type or format, many embodiments may comprise an identification indicator that includes the shipping entity's letterhead and/or logo.

The shipping entity's shipping signature 130 of the depicted embodiment includes a handwritten signature of the shipping contact person. However, in various other embodiments, the shipping signature may be any combination of text, figures, symbols, etc. that may be used by a shipping entity as a shipping signature. Although not necessarily requiring an original signature, many countries require that a handwritten shipping signature be included on a commercial shipping invoice. Thus, although the present invention should not be limited to a shipping signature of any particular type or format, many embodiments may comprise a handwritten shipping signature.

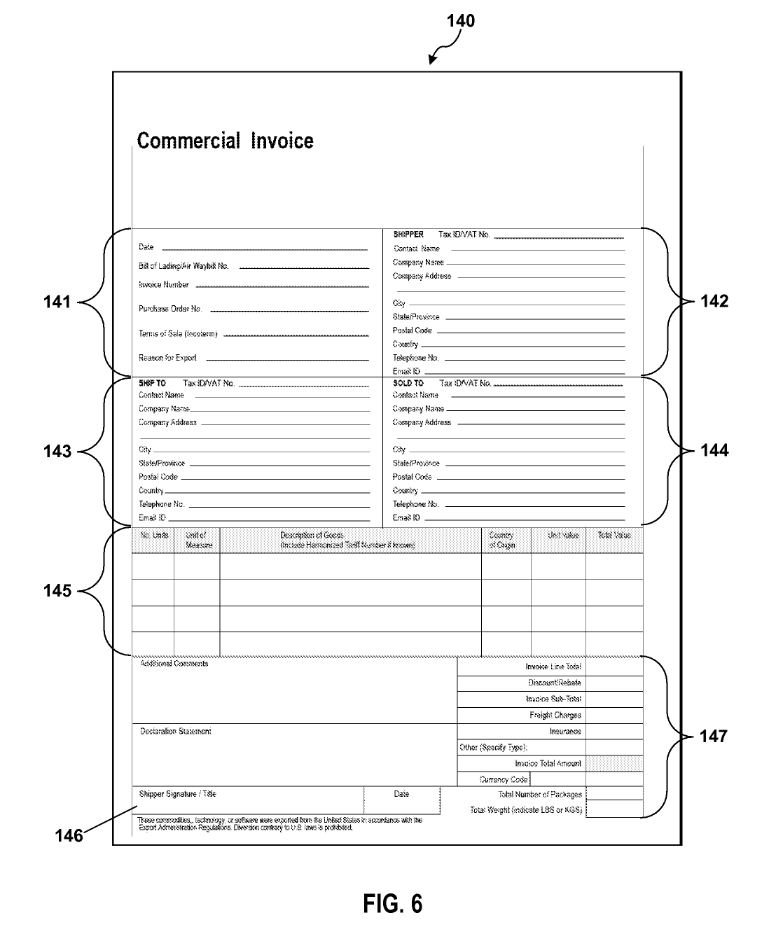

FIG. 6 shows an example of a commercial shipping invoice template 140 in accordance with one embodiment of the present invention. As shown in the drawing, a commercial invoice template 140 may be formatted so as to create a blank commercial shipping invoice. The commercial shipping invoice template 140 may include various portions representing information typically included on a commercial shipping invoice. Examples of such portions may include, but are not limited to, a general shipping portion 141, a ship-from portion 142, a ship-to portion 143, a sold-to portion 144, an item detail portion 145, a shipping signature portion 146 and an other shipment information portion 147. It should again be noted that although the depicted embodiment includes a commercial shipping invoice template 140, one need not be included in every embodiment of the present invention, as the invoice data 110 of some embodiments may be recorded in a format similar to a commercial shipping invoice template 140.

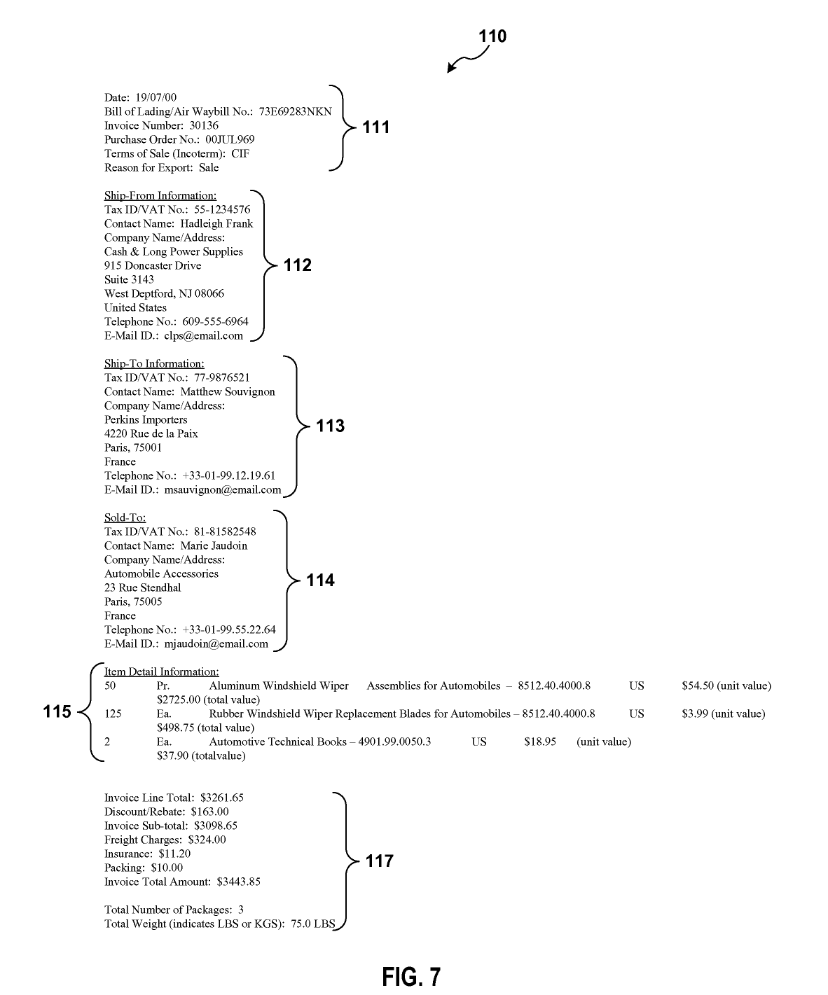

FIG. 7 shows a fictional example of invoice data 110. In the exemplary embodiment, the invoice data 110 includes general shipping information 111, ship-from information 112, ship-to information 113, sold-to information 114, item detail information 115, and other shipment information 117. Although not required by the present invention, shipping software, such as UPS WorldShip™ or other similar software, may be used by shipping entities to initiate an international parcel shipment. These software programs typically prompt a shipping entity for the invoice data 110 relating to a parcel shipment. The invoice data may then be recorded and transmitted to the carrier's server 20 where it may be stored.

In the depicted embodiment, general shipping information 111 includes, for example, the date that the invoice data was uploaded to the carrier's server, as well as a bill or lading/air waybill number. The general shipping information also includes an invoice number, purchase order number, terms of sale code, and a reason for export. The ship-from information 112 includes, for example, the name and address of the shipping entity, the tax ID/VAT number for the shipping entity, the shipping entity contact name, a shipping entity telephone number, and a shipping entity email address. The ship-to information 114 includes similar information for a ship-to entity, and the sold-to information 115 includes similar information for a sold-to entity, if different, as in the example, from the ship-to entity.

Item detail information 117 of the depicted embodiment includes, for example, quantity and item description information for the items included in the parcel shipment. Also included are unit values and total values for the items. Item detail information of the level of detail shown in the example of FIG. 7 is required for imported parcels by many countries. Thus, although the present invention should not be limited to any particular level of detail, many embodiments may comprise invoice data that includes parcel (package) level detail (PLD). PLD data may comprise a description of the items shipped, as well as quantity information, and value information. In the depicted embodiment, the item detail information 117 also includes country of origin information, as well as a total value and a unit of measure, per line item. The depicted embodiment also includes other shipment information, such as, for example, a discount rate, freight charges, insurance charges, and packing charges, as well as the total number of packages and the total weight of the parcel shipment.

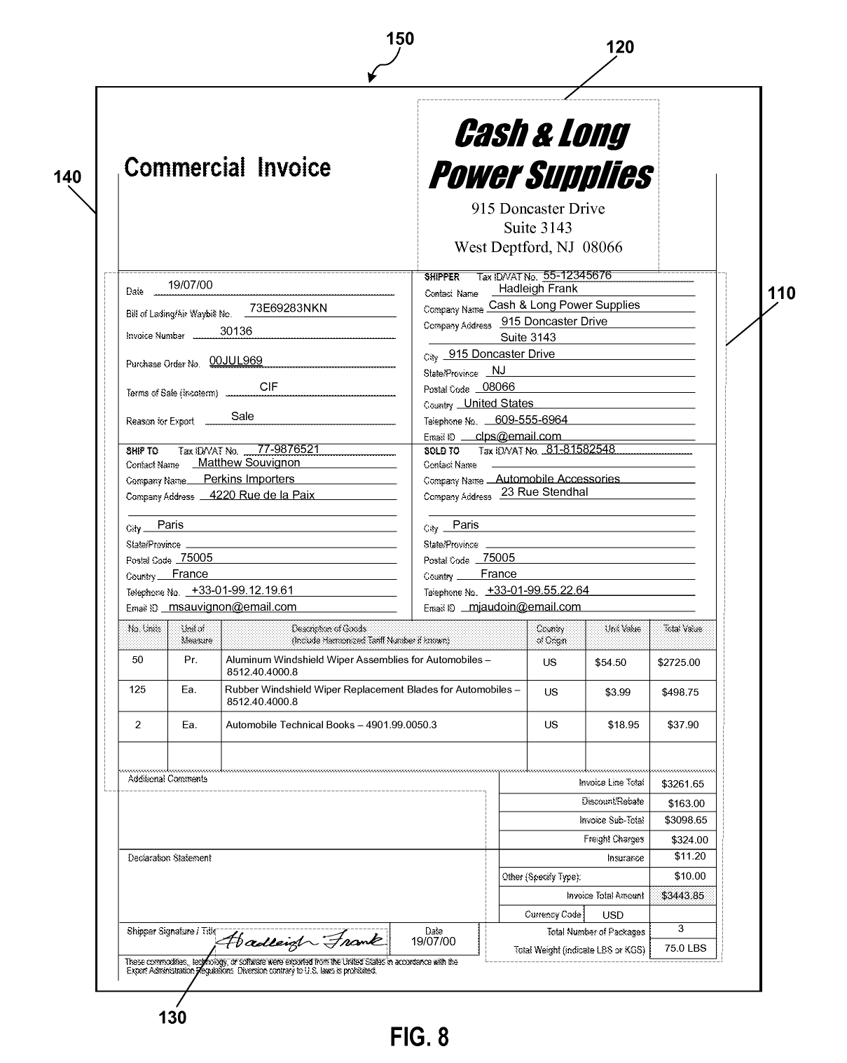

FIG. 8 shows a signed international commercial shipping invoice 150 resulting from the subsequent combining of the invoice data 110, the identification indicator 120, and shipping signature 130 components in accordance with the depicted embodiment of the present invention. Upon demand, such as for example, when initiated by a customs broker in response to an importing agent's request for further documentation regarding a parcel shipment, the invoice data 110 component is used to populate corresponding portions of the commercial invoice template 140, the identification indicator 110 component is placed onto an area proximate the top of the commercial shipping invoice template 140, and the shipping signature 130 is placed adjacent a shipping signature portion 146 of the commercial invoice template, thus creating a signed on demand signed international commercial shipping invoice 150 relating to the parcel shipment. In various embodiments, the populating of the template 140 and the placing of the identification indicator 110 and the shipping signature 130 may occur electronically, such as through code portions of a computer program product or application.

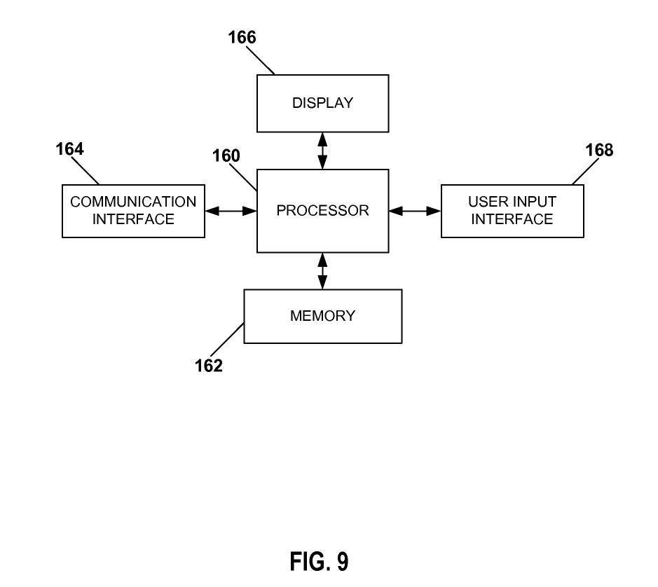

The foregoing merely illustrates how exemplary embodiments of the present invention create an on demand international commercial shipping invoice by subsequently combining invoice data with a shipping entity's identification indicator and shipping signature. Referring now to FIG. 9, a block diagram of an exemplary electronic device (e.g., PC, laptop, PDA, etc.) configured to execute the method of creating an on demand signed international commercial shipping invoice of exemplary embodiments of the present invention is shown. The electronic device may include various means for performing one or more functions in accordance with exemplary embodiments of the present invention, including those more particularly shown and described herein. It should be understood, however, that the electronic device may include alternative means for performing one or more like functions, without departing from the spirit and scope of the present invention. As shown, the electronic device may generally include means, such as a processor, controller, or the like 160 connected to a memory 162, for performing or controlling the various functions of the entity.

The memory can comprise volatile and/or non-volatile memory, and typically stores content, data or the like. For example, the memory typically stores content transmitted from, and/or received by, the electronic device. Also for example, the memory typically stores software applications, instructions or the like for the processor to perform steps associated with operation of the electronic device in accordance with embodiments of the present invention. In particular, the memory 162 may store computer program code for an application and other computer programs. For example, in one exemplary embodiment of the present invention, the memory may store computer program code for, among other things, storing an electronic copy of a shipping entity's identification indicator, storing an electronic copy of the shipping entity's shipping signature, receiving invoice data relating to the parcel shipment, and subsequently combining the identification indicator and the shipping signature with the invoice data to generate an on demand signed international commercial shipping invoice.

In addition to the memory 162, the processor 160 can also be connected to at least one interface or other means for displaying, transmitting and/or receiving data, content or the like. In this regard, the interface(s) can include at least one communication interface 164 or other means for transmitting and/or receiving data, content or the like, as well as at least one user interface that can include a display 166 and/or a user input interface 168. The user input interface, in turn, can comprise any of a number of devices allowing the electronic device to receive data from a user, such as a keypad, a touch display, a joystick or other input device.

As described above and as will be appreciated by one skilled in the art, embodiments of the present invention may be configured as a method or apparatus. Accordingly, embodiments of the present invention may be comprised of various means including entirely of hardware, entirely of software, or any combination of software and hardware. Furthermore, embodiments of the present invention may take the form of a computer program product consisting of a computer-readable storage medium (e.g., the memory 162 of FIG. 9) and computer-readable program instructions (e.g., computer software) stored in the storage medium. Any suitable computer-readable storage medium may be utilized including hard disks, CD-ROMs, optical storage devices, or magnetic storage devices.

Exemplary embodiments of the present invention have been described above with reference to block diagrams or flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of creating an on demand international commercial shipping invoice associated with shipment of a parcel, said method comprising:
storing an electronic copy of a shipping entity's identification indicator;
storing an electronic copy of the shipping entity's shipping signature;
receiving invoice data relating to the parcel shipment; and
subsequently combining the identification indicator and the shipping signature with the invoice data to generate an on demand signed international commercial shipping invoice.

2. The method of claim 1, further comprising providing an electronic commercial shipping invoice template and wherein the step of subsequently combining the identification indicator and the shipping signature with the invoice data comprises populating the electronic commercial shipping invoice template with the identification indicator, shipping signature, and invoice data.

3. The method of claim 1, further comprising associating the identification indicator and the shipping signature with the shipping entity.

4. The method of claim 1, further comprising determining a tracking number for the parcel shipment, associating the tracking number with the invoice data and the shipping entity, and storing the invoice data and the tracking number.

5. The method of claim 1, wherein the step of subsequently combining the identification indicator and the shipping signature with the invoice data occurs upon request for further documentation by an importing agent.

6. The method of claim 1, further comprising associating a printed shipping label with the parcel, the shipping label including machine readable data corresponding to the invoice data.

7. The method of claim 6, wherein the machine readable data is readable by at least one of a barcode reader, MaxiCode reader, a PDF417 reader, or an RFID reader.

8. The method of claim 1, wherein the step of receiving invoice data comprises receiving package level detail data.

9. The method of claim 1, wherein the step of storing an electronic copy of the shipping entity's identification indicator comprises storing at least one of the shipping entity's letterhead or the shipping entity's logo.

10. The method of claim 1, further comprising printing a paper version of the on demand signed international commercial shipping invoice upon request by an importing agent.

11. A computer program product for creating an on demand international commercial shipping invoice associated with shipment of a parcel, wherein the computer program product comprises at least one computer-readable storage medium having computer-readable program code portions stored therein, the computer-readable program code portions comprising:
a first executable portion for storing an electronic copy of a shipping entity's identification indicator;
a second executable portion for storing an electronic copy of the shipping entity's shipping signature;
a third executable portion for receiving invoice data relating to the parcel shipment; and
a fourth executable portion for subsequently combining the identification indicator and the shipping signature with the invoice data to generate a on demand signed international commercial shipping invoice.

12. The computer program product of claim 11, further comprising a fifth executable portion for providing an electronic commercial shipping invoice template, and wherein the fourth executable portion comprises populating the electronic commercial shipping invoice template with the identification indicator, shipping signature, and invoice data.

13. The computer program product of claim 11, further comprising a fifth executable portion for associating the identification indicator and the shipping signature with the shipping entity.

14. The computer program product of claim 11, further comprising a fifth executable portion for determining a tracking number for the parcel shipment, associating the tracking number with the invoice data and the shipping entity, and storing the invoice data and the tracking number.

15. The computer program product of claim 11, wherein the fourth executable portion occurs upon request for further documentation by an importing agent.

16. The computer program product of claim 11, further comprising a fifth executable portion for associating a printed shipping label with the parcel, the shipping label including machine readable data corresponding to the invoice data.

17. The computer program product of claim 16, wherein the machine readable data is readable by at least one of barcode reader, a MaxiCode reader, a PDF417 reader, or an RFID reader.

18. The computer program product of claim 11, wherein the third executable portion receives parcel level detail data.

19. The computer program product of claim 11, wherein the first executable portion stores at least one of the shipping entity's letterhead or the shipping entity's logo.

20. The computer program product of claim 11, further comprising a fifth executable portion for printing a paper version of the on demand signed international commercial shipping invoice upon request by an importing agent.
